(19) United States
(12) Patent Application Publication
(10) Pub. No.: US 2007/0151903 A1
(43) Pub. Date: Jul. 5, 2007

(54) Handling system for recycling of packages

(76) Inventor: Roy Olson, Kristinehamn (SE)

Correspondence Address: MANELLI DENISON & SELTER, 2000 M STREET NW SUITE 700, WASHINGTON, DC, 20036-3307, US

(21) Appl. No.: 10/552,044

(22) PCT Filed: Apr. 6, 2004
(86) PCT No.: PCT/SE04/00531

§ 371 Date: Aug. 30, 2006

(30) Foreign Application Priority Data
Apr. 7, 2003 (SE) 0301036-0

(51) Int. Cl. B07C 5/344

(52) U.S. Cl. 209/571; 209/930

(57) ABSTRACT

The present invention relates to a handling device for returnable packagings comprising a feeding device (A), having at least one inlet feed opening (16), a detection means (3) arranged in connection with said feeding device (A), for detection of at least one property of a returnable packaging present in the feeding device (A), in order to control/affect the operation in at least one subsequent unit (D; E), wherein a lock unit (B) is arranged before said subsequent unit (D; E), which lock unit (B) comprises a first (1) and a second (2) stop means, arranged to control that only one returnable packaging at a time is present at said second stop means (2). The invention also relates to a method for handling returnable packagings.

### TECHNICAL FIELD

The present invention relates to a handling device for returnable packagings comprising a feeding device, having at least one inlet feed opening, a positioning means arranged in connection with and a detection means arranged in connection with said positioning means, for detection of at least one property of the returnable packaging that is positioned by the positioning means, wherein a lock unit is arranged before said positioning means. The invention also relates to a method for handling returnable cans.

### PRIOR ART

The demands on handling of returnable cans/bottles of varying types are ever increasing. A long known recycling system is based on the customer himself selecting and feeding in one and the same type of returnable can/bottle in an apparatus especially intended therefore. Accordingly, most of today's shops have a variety of apparatuses in order to be able to handle different types of returnable cans/bottles. Of course, the variety of apparatuses results in costs, and space requirements.

From SE 465743 a handling device is known for identification, sorting and compressing, respectively, of returnable packagings in the form of metal cans. Accordingly, this handling device is only intended to be used for metal cans. Evidently, it is a disadvantage that the handling device is unable to handle also returnable packagings of plastics, such as PET-bottles. Furthermore, this known device has a complicated sorting mechanism in order to distinguish between different types of metal cans. The sorting mechanism comprises a rotatable rock by which the moment of inertia of the metal can is determined in order to decide if the can is to be sorted for return compression or be discarded, and this means that the detection method becomes undesirably slow. Moreover, the device demands advanced calibration and thorough maintenance in order for the intended sorting function to be maintained. Yet another disadvantage of the device is that discarded cans are not compressed at all, resulting in additional handling being necessary in order to compress discarded cans. Moreover, the device itself is expensive, amongst other things because the sorting device must be driven by a rotating unit An additional disadvantage is that the handling device has no mechanism ensuring that only one can at a time is positioned in the sorting/detection area Accordingly, the shown handling device has no means arranged to securely prevent simultaneous feeding-in of two cans to the rotating sorting equipment, which may result in stoppage of the system or in worst case system damages.

### ACCOUNT OF THE INVENTION

It is an object of the present invention to eliminate, or at least minimize, the above mentioned problems, which is achieved by a handling device according to claim 1.

Thanks to the handling device according to the invention, a fast and problem-free feed of returnable packagings through the device is secured, so that a secure f urther handling of the returnable packagings can be achieved.

According to preferred aspects of the invention:
the first stop means is arranged to be closed when a returnable packaging is in a position between the first and the second stop means. Thanks to this, it is secured that only one returnable packaging at the time can be in a buffer position and ready to be fed on, which gives good speed and reliability.
the first stop means is arranged to be openable when there is no returnable packaging present between the first and the second stop means, preferably by use of a detector arranged between the first and the second stop means, respectively. Thanks to this arrangement, it is secured that the feed through the handling device always is fast and efficient
the second stop means is arranged to be open when the subsequent unit is empty and in position to receive a returnable packaging. Thanks to this arrangement, it is secured that there never is more than one packaging at a time in position in a subsequent unit.
the feeding device is continuously acting on returnable packagings, preferably by gravity. Thanks to this, an efficient feed through the handling device is obtained, and in the preferred case when gravity is used, a particularly cost efficient continuous feed through the device is obtained.
A sorting unit is arranged after the feeding device, which sorting unit is arranged to guide a returnable packaging in at least two different directions. Thanks to this, different types of returnable packagings can be fed in different direction for rational handling of the flow of different types of returnable packagings.
the sorting device is arranged to be controlled by a control signal based on information from the detection means. Thanks to this, a cost efficient sorting device is achieved, which in a quite simple way allows the returnable packagings to be guided in different directions.
a compressing unit is arranged between the sorting unit and the feeding unit. Thanks to this arrangement, a cost efficient handling device is achieved, in which one and the same compressing unit can be used for different types of returnable packagings, since the sorting takes place only after passage through the compressing unit.
said compressing unit is arranged to compress a returnable packaging in its axial direction. Thanks to this, a more optimal compression is obtained than if the returnable packagings are compressed in their lateral direction. Often, a compression degree of more than 50% is obtained at axial compression as compared to a returnable packaging that is compressed laterally, as is conventional.
a positioning means in the form of a holder-on, is arranged to position a returnable packaging by preventing a continued movement through the feeding device. Thanks to this, a cost efficient solution is obtained to position the returnable packaging in connection with detection.

The invention also relates to a method in connection with the handling of returnable packagings, comprising feeding of a returnable packaging through a feeding device, detection of at least one property of a returnable packaging and sorting of the returnable packaging dependent of information from said detection, whereby the returnable packaging is compressed before the sorting of the returnable packaging takes place.

### DESCRIPTION OF DRAWINGS

In the following, the invention will be described in greater detail with reference to the attached drawing figures, of which:

FIG. 1 shows a conceptual solution for a preferred device according to the invention, which device is able to handle different types of cans/bottles,

FIG. 2 shows a stop means/positioning means in a compressing unit according to a first preferred embodiment of the invention,

FIG. 3 shows the same compression means and stop/positioning means as in FIG. 2, but in another position, and

FIG. 4 shows a modified embodiment of a handling device according to the invention.

### DETAILED DESCRIPTION

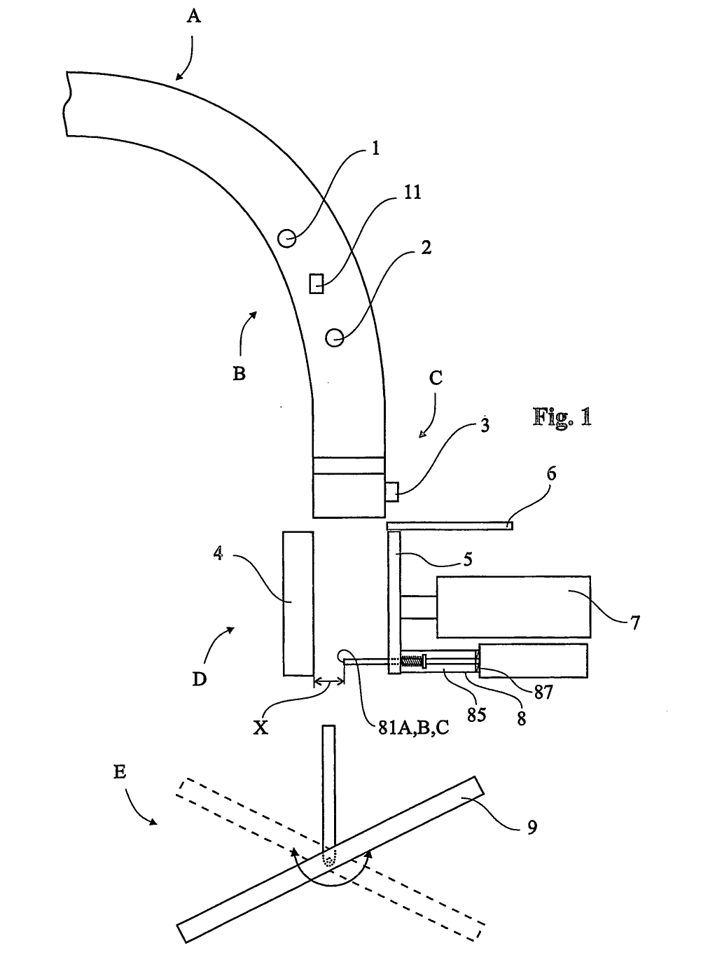

FIG. 1 shows a conceptual solution in which one and the same apparatus is able to handle different types of cans/bottles. The apparatus comprises an inlet feed pipe A, a lock section B, a detection section C, a compressing section D and a sorting section E. The lock unit B consists of a buffer piston 1, a stop piston 2 and a photocell 11. The object of the lock unit is to make sure that only one object (can/bottle) at a time is present in the detection unit C. Normally, the stop piston 2 is always in blocking position, while the buffer piston 1 normally is in open position. Only when the photocell detects that an object has arrived, the buffer piston 1 will move into a blocking position, so that only one unit at a time will be able to fall down as the stop piston 2 is released. In the next step, the buffer piston 1 is released, and so on.

The detection section C consists of at least one, preferably two, inductive gauges 3. By aid of an inductive gauge 3, it is possible to distinguish between metal and plastics. Later on, this information is used to determine the position of the sorting unit E. If two inductive gauges are used, the detection unit can also decide whether a can is an aluminium can or it is a tin can. When the object is dropped down by the stop piston 2, a movable base plate 6 at the compressing unit D will be in a blocking position at the discharge mouth of pipe A.

The compressing unit D consists of a fixed press plate 4, a moveable press plate 5 and a press cylinder 7. Accordingly, the base plate 6 is arranged on top of the movable press plate 5 and with a backward extension. A stop means 8 is also fixedly connected to the moveable press plate 5, at its lower end. The object of the stop means 8 is to position the object before compression, i.e. to stop the object as it falls off from the support plate 6, which accordingly takes place as the press plate 5 moves backwards. As soon as the object has been compressed by the compressing unit D, by the cylinder unit 7 having moved the plate 5, the plate 5 will be returned, so that the compressed object can fall down in direction towards the sorting unit E.

The sorting unit E consists of a rocker plate 9 that is controlled by a pneumatic piston unit (not shown), to one or the other position, whereby PET-bottles are sorted in one direction and metal cans in the other direction. (Thereafter, a not shown magnetic sorting device can be used to sort tin from aluminium.)

By aid of this simple and compact design (one inlet feed device, one compressing unit), it is accordingly possible to efficiently handle different types of cans/bottles for recycling. (A not shown, per se conventional reading unit, for bar-codes e.g., is arranged in connection with the inlet feed pipe A.)

The stop means 8 is a mechanical device that secures that the unit operates without risk of stoppage, by never providing a larger opening X at the discharge of the compressing unit D, than that needed to always and securely stop all types of cans/bottles that fall down, and by always providing adequate and unhindered opening after compression of an object, by the front ends 81A, B, C of the stop means 8 not projecting outside the press surface 51 of the movable press plate, at finished compression.

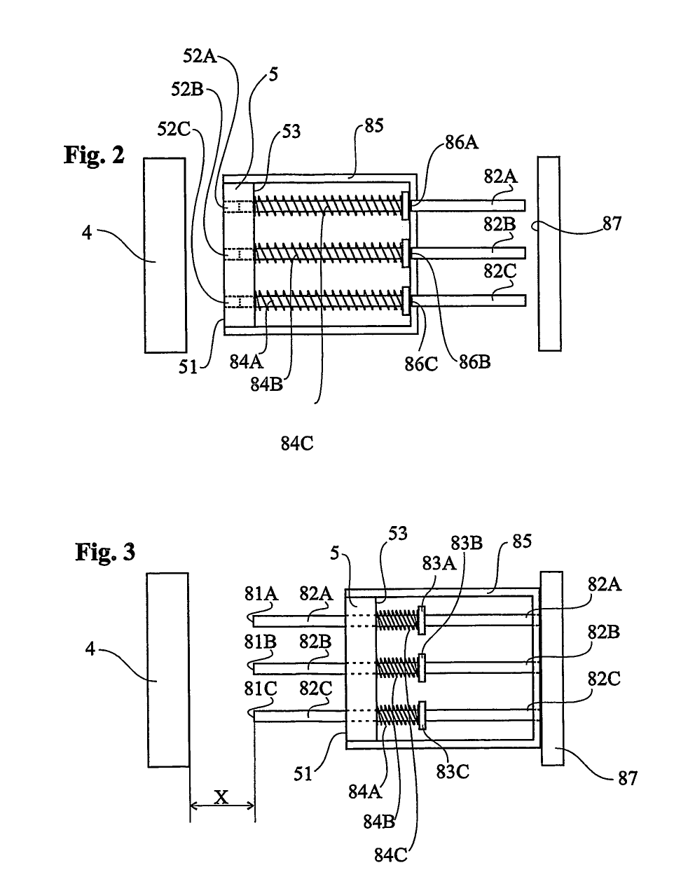

FIG. 2 shows how the stop means 8 has been arranged by aid of three rods 82A, B, C in respective holes 52A, B, C in the press plate 5. Flanges 83A, B, C are also arranged at each rod 82A, B, C, respectively. Springs 84A, B, C are arranged around each rod 82A, B, C, respectively, between the rear surface 53 of the press plate and said flange. Also, a guide bracket 85 is attached to the press plate 5, which bracket 85 is provided with guide holes 86A, B, C for the respective rods 82A, B, C. A stop wall 87 is fixedly attached to the apparatus and interacting with the rear ends of rods 82A, B, C.

FIG. 3 shows that when the press plate 5 moves to its rearmost position, the rearmost ends of rods 82A, B, C will abut stop wall 87, so that the springs 84A, B, C are compressed, whereby the ends 81A, B, C project from the press plate 5. As the press plate 5 moves away from the stop wall 87 (see FIG. 2) the springs 84, B, C will push back the rods 82A, B, C, so that their front ends 81A, B, C do not project in front of the press surface 51. By allowing an adequately long distance between the stop wall 87, the press plate 5, and adapting the length of the rods 82A, B, C, there is a possibility to have a completely free opening X between the fixed 4 and the moveable 5 press plate for a desired portion of the opening movement, so that the compressed object does not risk being caught on the front ends of the rods. Thereafter, the rearmost ends of the rods 82A, B, C will contact stop wall 87, so that during the continued return movement the springs 84A, B, C are compressed, whereby the “stop” is formed.

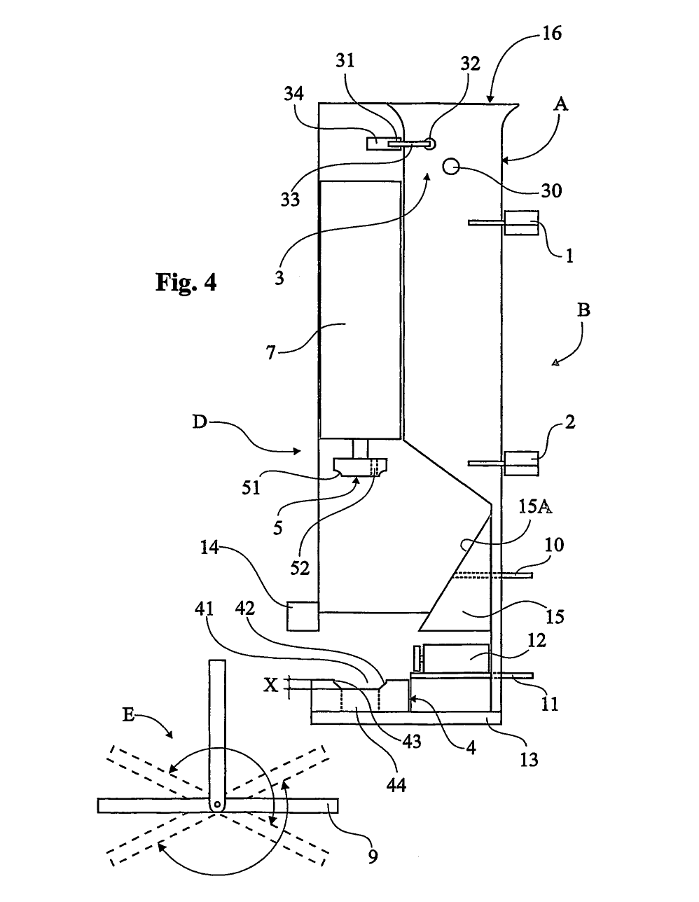

FIG. 4 shows a preferred embodiment of a compressing unit D according to the invention, by which returnable packagings can be compressed axially, so that a higher degree of compaction can be achieved as compared to transversal compression. It is realised that this compressing unit D, or only essential parts thereof, are applicable to other types of handling devices for returnable packagings, i.e. also without a preferred lock unit B and without a sorting unit E, respectively.

The device shown in FIG. 4 has some differences compared to the principle shown in FIG. 1. A first such difference is that the device shown in FIG. 4 is intended for manual feed only. Another important difference is that the device in FIG. 4 is intended for compression of metal cans only. Before further detailed description, it must be pointed out that the Fig. is purely an explanatory sketch, not showing cross-sections/section lines etc. Accordingly, the only object of the Fig. is to elucidate the function of the device and details included therein.

Similarly to the device shown in FIG. 1, there are two stop means 1,2, preferably arranged in the form of pneumatic cylinders. Accordingly, the object of these stop means 1, 2 is to retain a returnable packaging until a signal is received, after which they open up to let through a can that rests on top. The first stop means 1 is positioned at such level below the inlet feed opening 16, that only the lower half of the can is inside the feed pipe A An inductive gauge 30 is arranged to determine if it is a metal can. If a plastic bottle enters, the first stop means will accordingly not open up, since no signal is received from the inductive gauge 30. In addition, a magnetic breaker 31-34 is arranged to select tin cans from aluminium cans. Accordingly, the first stop means 1 will open up only when the detection means 3 has secured that it is an aluminium can. This is the case when the inductive gauge 30 detects a metal object at the same time as the magnetic breaker 31-34 is unactivated. The magnetic breaker 31-34 is a simple device consisting of a permanent magnet 32 arranged at one end of a pivot arm 33. The other end 32 of the pivot arm 33 interacts with a simple breaker 34, such that when a magnetic object is in level with the breaker 31-34, the magnet 32 will be attracted to the can so that the breaker 32 opens, which in turn leads to the stop means 1 being kept closed. Accordingly, the person feeding-in a returnable packaging that is not of aluminium, must first lift it out (i.e. the tin can or the plastic bottle) before a new can can be fed into the opening 16, whereby a simple manual selection is obtained. Suitably, the device is complemented by a signal lamp or signal lamps, so that the user can see quite easy if a packaging is not allowed. Contrary to FIG. 1, no detector is used between the stop means 1, 2, but instead a control system (not shown) is used that controls that the first stop means 1 is not allowed to open up until the second stop means 2 already has been opened up or closed, respectively.

Similarly to the embodiment according to FIG. 1, a lock unit is achieved by the two stop means 1,2, which makes the device more efficient and secures the feed through the handling device. When an aluminium can has been detected by the detection device 3, the first stop means 1 is opened up, where after the can falls down towards the second stop means 2. The second stop means 2 will only open up when it receives a signal that the compressing unit D is empty, i.e. when there is no other can in the compressing unit. This is controlled by aid of a photocell 14, that gives a stop signal if a can (or some other larger object) is on top of the fixed press plate 4. In addition, the photocell 14 preferably has the quality to the detect that a can is properly positioned, before the actual compression takes place, by giving go-ahead signal only when the can rests upon the fixed press plate 4.

When the second stop means 2 opens up, the can will accordingly fall down by gravity towards the fixed press plate 4. A guide surface 15A is arranged below the inlet feed pipe A, which guide surface is angled in order to guide the can towards the centre point of the fixed press plate 4. Suitably, the guide surface 15A is arranged by application of a triangular element 15 below the extension of the feed pipe A. The reason for arranging an angled guide surface 15A is that the design of the machine is advantageously compact, which hence is achieved by arranging the cylinder unit 7 for the press D in parallel with and overlapped with the inlet feed pipe A. It is also shown that a first blowpipe 10 is arranged at about centre level of the triangular element 15. The object of this blowpipe 10 is to make sure that the can on its way down is moved in direction towards the opposite side wall inside the press D, where walls are arranged to position the can in a vertical standing position.

The fixed plate 4 rests on a solid base plate 13, the parts of which being easy to detach (not shown) in order for easy cleaning of the compressing unit D. An annular recess 41 is arranged at the fixed plate's centre. This recess 41 has an inner edge area 42 in the form of the surface 42 of a frustrum of a cone, with adjoining vertical outer edges 43. The purpose of this design is to securely position the can during compression operation. The depth X of the recess 41 is very limited and need not be more than about 2-3 mm in order to get the desired positioning of the can. Suitably, the conical surfaces 42 are of about 45°±30°. A hole 44 at the centre of the recess is also shown.

The moveable press plate 5 is also provided with means 51 having the object of securing that the can is retained during compression operation. According to the preferred example, this is shaped as an annular groove/chamfering that enables a centering of the can as the moveable press plate 5 moves down and compresses the can. As the press unit 7 is activated, an aluminium can can quite easily be compressed to a packet of about 9 mm height. Accordingly, about 7 mm of the can will project above the fixed press plate 4. By aid of air from a second blowpipe 11, the compressed can can quite easily be removed from the compressing unit D. To be on the safe side, the device may however also be provided with an out-pushing unit 12, suitably in the form of a simple air cylinder unit. The out-pushing unit 12 need only be used at extreme circumstances, as tests have shown that the air exhaust 11 is fully adequate in all normal situations to give feeding out

A sorting unit E can be used after feeding-out, which is based on exactly the same principles as have been described in connection with FIG. 1. Accordingly, a simple sorting of different types of aluminium cans can take place by aid of the pivot arm 9. However, in most applications in which only aluminium cans are compressed, as is the case of this device, a sorting unit E is usually not needed.

The invention is not limited to what has been shown above but may be varied within the scope of the claims. It is for example realised that the concept of a feeding device must be interpreted in a broad sense according to the invention and that there accordingly is no distinct line between a feeding device and a lock device, but that these of course may be overlapping. It is also realised that the feeding device can be any conventional feeding device and that the handling device can operate both at continuous and at intermittent feed, respectively. The skilled person will also realised that a variety of detection means can be used to fulfil the purpose according to the invention. It is also obvious to the skilled person that many, from the above described differing, stop means and positioning means, respectively, can be used to fulfil the object of the invention. It is also obvious to the skilled person that a variety of mechanisms can be used to give the basic functions of a compressing unit according to the invention, and that this also is true for the sorting unit. In addition, it is obvious that the different units not necessarily need to be arranged in the above described order. For example, it is obvious that the lock unit as such can be advantageous also for use in other contexts than compression/sorting, at the handling of returnable packagings. In the same way, it is obvious that the compression unit as such can be useful in other contexts in the handling of returnable packagings, without necessarily having to be connected with a lock unit, for example by using manual feed. In the same way, it is obvious that the sorting unit can be used without a preceding compressing unit, which may be desirable for some types of handling of returnable packagings.

1-13. (canceled)

14. A handling device for returnable packagings comprising a feeding device, having at least one inlet opening, a first detection device arranged in connection with said feeding device, means for detection of at least one property of the material of a returnable packaging, in order to control/affect the operation in a subsequent sorting unit, wherein a lock unit is arranged before said sorting unit, and a compression unit, wherein said lock unit comprises a first and a second stop device, arranged to control that only one returnable packaging at a time is present at said second stop device, wherein said means comprises a second detection device arranged within said feeding device, which second detection device includes a gauge arranged to distinguish between metal and plastic, and that said sorting unit is moveable arranged, between different positions, based on a control signal from said second detection device, in order to dependent of its material direct the returnable packaging into one of at least two different directions.

15. A handling device according to claim 14, wherein the first stop device is arranged to be closed when a returnable packaging is in a position between the first and the second stop device.

16. A handling device according to claim 15, wherein the first stop device is arranged to be open able when there is no returnable packaging present between the first and the second stop device, preferably by use of a detector arranged between the first and the second stop device, respectively.

17. A handling device according to claims 14, wherein the second stop device is arranged to be open when a positioning device is empty and in position to position/retain a returnable packaging for detection, by the second detection device.

18. A handling device according to claims 15, wherein the second stop device is arranged to be open when a positioning device is empty and in position to position/retain a returnable packaging for detection, by the second detection device.

19. A handling device according to claims 16, wherein the second stop device is arranged to be open when a positioning device is empty and in position to position/retain a returnable packaging for detection, by the second detection device.

20. A handling device according to claim 14, wherein the feeding device is continuously acting on returnable packagings.

21. A handling device according to claim 20, wherein the feeding device is continuously acting on returnable packagings by gravity.

22. A handling device according to claim 14, wherein a compression unit is arranged after the feeding device and before a sorting unit.

23. A handling device according to claim 14, wherein at least one stop/positioning device is arranged in the form of a holder-on arranged to position a returnable packaging by preventing its continued movement through the feeding device.

24. A handling device according to claim 14, wherein said second gauge comprises at least one inductive gauge.

25. A method in connection with the handling of returnable packagings, comprising a feeding device, compressing said returnable packaging in a subsequent compression unit and sorting of the returnable packaging in a sorting unit that is subsequent to the compression unit, wherein the detection of at least one property of material of the returnable packaging is performed in the feeding device in order to control the subsequent sorting of the returnable packaging and that both plastic and metal packagings are compressed in the same compression unit.

26. A method according to claim 25, wherein subsequent to the sorting unit there is arranged a magnetic sorting device, arranged to sort an aluminium can from other metal cans.
